(19) United States
(12) Patent Application Publication
(10) Pub. No.: US 2009/0286712 A1
(43) Pub. Date: Nov. 19, 2009

(54) Concentrated Esterquat Composition

(75) Inventors: Manlio Gallotti, Sao Paulo (BR); George Italo Pitombeira Nunes, Sao Paulo (BR); Patricia Ramos P. DeMoraes, Sao Paulo (BR); Natanael DeAlmeida, Sao Paulo (BR); Claudia Barge, Sao Paulo (BR); Gustavo Kume, Sao Paulo (BR); Denise Aqarecida Acacio, Sao Paulo (BR)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT (BRAZIL) S.A., Sao Paulo-SP (BR)

(21) Appl. No.: 12/307,548

(22) PCT Filed: Jul. 3, 2007
(86) PCT No.: PCT/EP07/05861

§ 371 Date: Feb. 24, 2009

(30) Foreign Application Priority Data
Jul. 6, 2006 (EP) 06013997.9

(51) Int. Cl. C11D 3/00

(52) U.S. Cl. 510/527

(57) ABSTRACT

A concentrated esterquat composition is claimed which is especially suitable for low temperature process for production of a stable, homogenous and viscous liquid softener formulation. This concentrated esterquat composition consists of from about 50 to 95% by weight of an esterquat compound of the formula

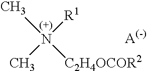

wherein R¹ is —C₂H₄OH or —C₂H₄OCOR², R² is C₁₁-C₂₁-alkyl or alkenyl and A is an anion, as methylsulfate, bromide, iodide and, preferably, chloride, said esterquat being prepared by esterification of methyldiethanolamine with fatty acids and subsequent quaternization with preferably methylchloride, the fatty acids containing at least 50% by weight of saturated C₁₈-fatty acid, comprising a final product containing at least 50 mol % of diester quat and at least 10 mol % of monoesterquat and having an acid value of less than 0.120 meq/g of esterquat active material, the rest being water and an organic solvent.

This invention relates to a concentrated pre-mixture of dimethyldiethanolamine esterquat composition used for production of fabric softeners at lower temperatures when compared to conventional process.

The dispersion of cationic compounds, mainly those suitable for the application in fabric softeners, is a hard task to be achieved at lower temperatures, due to the poor solubility/dispersibility of these raw materials in cold water.

The present invention discloses a new option for working with esterquats in the production of fabric softeners, basically consisting of a highly concentrated esterquat composition dispersible in water at temperatures below 60° C.

An interesting advantage comes from the dispersion at lower temperatures. In some countries, consumers still relate the quality of a product to its viscosity. For them, the higher the viscosity, the better the product is. However, esterquats usually present problems concerning the production of viscous softeners, obliging the use of thickeners to achieve a high viscosity in the final product. The dispersion at lower temperatures allows a significant reduction or even the removal of the thickeners from the formulation.

Many patents have claimed the use of dimethyldiethanolamine esterquats for fabric softener formulations. Patent WO 01/42412 claims the use of a softening compound having a transition temperature of less than 30° C. for providing good in-wear comfort. Unsaturated dimethyldiethanolamine esterquats present a transition temperature below 30° C., but when saturated, which are the preferred composition of the present patent, they present a transition temperature above that. In patent WO 01/34743, dimethyldiethanolamine esterquats are cited among the preferred quaternary ammonium compounds. However, it is also claimed the obligatory use of metal chelating agents. The patent WO 99/27046 cites dimethyldiethanolamine esterquat as a possible cationic compound for rinse-added fabric softening compositions, including translucent or clear liquid compositions, but it is obligatory to associate it with a polyoxyalkylene alkyl amide surface active agent. A concentrated esterquat composition with water and solvent is disclosed in the patent application JP 10 251 972. However, in this patent it is also claimed the obligatory use of alkali or alkaline earth metal salts which are included in the present invention as optional ingredients.

It has now been found that concentrated compositions of dimethyldiethanolamine esterquat can be made which, upon dilution, provide an enhanced viscosity.

The invention provides concentrated esterquat compositions containing from about 50 to 95% by weight more preferably from 60 to 85% by weight, even more preferably from 65 to 80% by weight of an esterquat compound of the formula

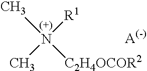

wherein R¹ is —C₂H₄OH or —C₂H₄OCOR², R² is C₁₁-C₂₁-alkyl or alkenyl and A is an anion, as methylsulfate, bromide, iodide and, preferably, chloride said esterquat being prepared by esterification of methyldiethanolamine with fatty acids and subsequent quaternization, with preferably methylchloride, the fatty acids containing at least 50% by weight of saturated C₁₈-fatty acid, comprising a final product containing at least 50 mol % of diester quat and at least 10 mol % of monoesterquat and the esterquat active material having an acid value of less than 0.120 meq/g, the rest being water and an organic solvent.

The concentrated composition described in this scope can be stored at suitable temperature for a period of time before the preparation of final softener formulation or it can be formulated in-situ, just before the preparation of the final softener formulation.

In order to obtain viscous formulations, we have found that there are some parameters that are important to optimize the viscosity increase. As it can be seen in the examples, the Acid Value of the raw material must be less than 0.12 meq/g of esterquat active material, otherwise the viscosity of the final formulation will be significantly lower.

The group —COR² is preferably derived from natural occurring fatty acids such as capronic acid, caprylic acid, caprinic acid, lauric acid, myristiric acid, palmic acid, isostearic acid, stearic, oleic acid, eluidinic acid, arachinic acid, behenic acid and eruca acid. Preferred acids containing the group —COR² are C₁₂/C₁₈ coco fatty acids, tallow fatty acid, fully or partially hydrogenated tallow fatty acid, palm fatty acid, partially or fully hydrogenated palm fatty acid or stearic acid.

These esterquats are made by methods known per se, for example by esterification of methyl-diethanolamine with a fatty acid of the formula R²COOH and subsequent quaternization with preferably methylchloride or dimethylsulfate or any other quaternization agent introducing a methyl group. The fatty acids used must be of such kind that they contain at least 50% by weight of saturated C₁₈-fatty acid. Preferably the fatty acid is derived from vegetable and/or animal fatty acid and contains at least 50 by weight of saturated fatty C₁₈-acid, more preferably from 52 to 90% by weight of saturated C₁₈-fatty acid and even more preferably from 55 to 85% by weight of saturated C₁₈-fatty acid. The molar relationship in the esterification between methyldiethanolamine and fatty acid must be such that the relationship of at least 50 mol-% diester quat and at least 10 mol-% monoesterquat is maintained.

### Organic Solvent

In principle, suitable organic solvents are any mono- or polyhydric alcohols. Preference is given to using alcohols having from 1 to 4 carbon atoms, such as methanol, ethanol, propanol, isopropanol, straight chain and branched butanol, glycerol and mixtures of said alcohols. Other preferred solvents are polyethylene glycols having a relative molecular mass below 2000. The claimed composition may contain these organic solvents in an amount of from 5 to 20% by weight of the whole composition.

### Water

Water is usually used as filler in a formulation. However, in the present invention, its presence in the concentrate is essential to the dispersibility at lower temperatures. In the claimed composition, water is present in an amount of from 1 to 20% by weight of the whole composition, preferably from 5.1% to 20% by weight of the whole composition.

Depending on the intended use, the compositions according to the invention comprise, in addition to the mentioned compounds, additives and auxiliaries which are customary and specific in each case such as for example stabilizers, perfumes, colorants, hydrotopes, antifoaming agents, polymeric or other thickening agents, opacifiers, preservatives and anti-corrosion agents.

Stabilizers and/or other additives can be selected from the group of specific organic and/or inorganic compound, preferably electrolytes and/or short amines derivates. A problem of aqueous compositions containing these esterquats is that they are not stable over prolonged storage since they undergo hydrolysis. It has been found that, apart from alkali and alkaline metal salts, there are also other metal salts capable of preventing hydrolysis of esterquats

In order to enhance the stability of the aqueous esterquat compositions, a salt may be added such as alkali or alkaline earth metal salt. Preferred salts, however, are transition metal salts, more preferably zinc and aluminium salts such as ZnSO₄, ZnCl₂, AlCl₃ or Al₂(SO₄)₃. These salts may be present in an amount preferably from 0.002 to 10.0, preferably 0.03 to 5.0, and even more preferably 0.04 to 3.0% by weight.

The compositions according to the present invention can be made by mixing the cited salts to the dimethyldiethanolamine esterquats disclosed in this invention in the final softener formulations. The salt can be added at any moment during the softeners process preparation and either in solid form or an aqueous solution. Heating and stirring is recommended for making the claimed compositions.

In order to make easier the preparation of the disclosed invention, a concentrated pre-mix containing the same molar and/or mass ratio between the esterquats and the additives can be prepared in order to be diluted up to 45 times. Other ingredients such as solvent, water or any ingredient that could be part of the final formulation may be added.

The compositions according to the invention may have the presence of rare earth metal salts, metal salts of fatty acids, phthalocyanine metal complexes, phthalocyanine metal salts or chelating agents.

Another option for stabilizers is short amines, which can be selected from the group of amines containing at least one hydroxyethyl group.

The compositions according to the present invention can be made by melting the esterquat compound and adding the organic solvent to the molten esterquat. Water is then added to the mixture of the esterquat and the organic solvent, which was previously cooled down to approximately 40 to 50° C.

### EXAMPLES

An example of the procedure to obtain a stable, homogeneous and viscous fabric softener formulation based on methyldiethanolamine esterquat as described on claim 1 of the present invention is:

I. Heating of water to 45° C.
II. Addition of the dimethyldiethanolamine esterquat pre-dispersion at 50° C.
III. Cooling under stirring with approximately 150 rpm for 30 minutes
IV. Fast cooling under stirring for 15 minutes

The fabric softener formulation prepared according to the procedure and to the dimethyldiethanolamine esterquat disclosed in this invention exhibits good viscosities results, especially for low active-material levels as shown on tables I and II. Moreover, table I proves the important effect that the acid value content has on the fabric softener formulation viscosity. The acid value, in addition with saturated C18 content and ester distribution are important parameters disclosed in this invention. On table II a comparative with other well-known softener active agents such as DSDMAC and Triethanolamine esterquats is shown. For the latter, it was used a pre-dispersion of triethanolamine esterquat as described on Patent EP1 584 674. This pre-dispersion, as the one prepared for the dimethyldiethanolamine esterquat disclosed in this patent, is used to decrease process temperature in order to increase viscosity results.

The results shows that with the dimethyldiethanolamine esterquat disclosed in this invention a viscous softener formulation is obtained, even for fabric softeners containing 2% am, and the fabric softeners viscosity results are clearly better than fabric softeners prepared through the other two cited softener active agents. It is important to notice that for a softener formulation based on a commercial available triethanolamine esterquat achieve the same viscosity levels of the fabric softener formulation based on dimethyldiethanolamine esterquat disclosed in this patent, a large amount of thickener would be necessary. This is, in fact, a characteristic of the commercial available triethanolamine esterquats that is the low fabric softeners viscosity values when working with low active material content, even using its pre-dispersion.

On table III it is clear the advantage of working with the concentrated esterquat pre-dispersion comparing with using an esterquat composition as is. As it can be seen and is disclosed in this invention, when using the pre-dispersion, besides the reduction on the process temperature, it is clear the improvement on the softener formulation viscosity.

TABLE I

| | Dimethyldi- | Dimethyldi- | Dimethyldi- |
|---|---|---|---|
| | ethanol-amine | ethanol-amine | ethanol-amine |
| | Esterquat 1 | Esterquat 2 | Esterquat 3 |
| Saturated C18 | >50% | >50% | >50% |
| Content (%) | | | |
| Acid Value (meq/g of | 0.132 | 0.031 | 0.031 |
| final product) | | | |
| Diester Content | >50% | >50% | >50% |
| (mol %) | | | |
| Monoester Content | >10% | >10% | >10% |
| (mol %) | | | |
| Fabric Softener | 20 | 1275 | 1730 |
| with 2% am | | | |
| Viscosity (mPas) | | | |
| Fabric Softener | 550 | 2790 | 2735 |
| with 4% am | | | |
| Viscosity (mPas) | | | |

TABLE II

| | Dimethyldi- | | Triethanol- |
|---|---|---|---|
| | ethanolamine | | amine |
| | Esterquat 2 | DSDMAC | esterquat |
| Fabric Softener with 2% am | 1275 | 35 | 20 |
| Viscosity (mPas) | | | |
| Fabric Softener with 4% am | 2790 | 2165 | 210 |
| Viscosity (mPas) | | | |

TABLE III

| | Dimethyldi- | Dimethyldi- |
|---|---|---|
| | ethanolamine | ethanolamine |
| | Esterquat 4 | Esterquat 4 |
| | As is | Pre-dispersed |
| Process Temperature | 65/70 | 50/55 |
| (Water/am) | | |
| Fabric Softener with 2% am | 40 | 1400 |
| Viscosity (mPas) | | |

1. A concentrated esterquat composition especially suitable for low temperature process for production of a stable, homogenous and viscous liquid softener formulation comprising:
from about 50 to 95% by weight of an esterquat compound of the formula 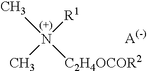
wherein R¹ is —C₂H₄OH or —C₂H₄OCOR², R² is C₁₁-C₂₁-alkyl or alkenyl and A is an anion, as methylsulfate, bromide, iodide and, chloride, wherein the esterquat is prepared by a process comprising the steps of esterifying methyldiethanolamine with a fatty acid mixture wherein the fatty acid mixture contains at least 50% by weight of saturated C₁₈-fatty acid, to form an esterified methyl-diethanolamine and subsequently quarternizing the esterified methyldiethanolamine, wherein the final esterquat product contains at least 50 mol % of diester quat and at least 10 mol % of monoesterquat and has an acid value of less than 0.12 meq/g of esterquat active material, the rest being water and an organic solvent.

2. A composition as claimed in claim 1 which contains from about 5 to 20% of a low molecular weight alcohol selected from the group consisting of ethanol, isopropanol alcohol and mixtures thereof as organic solvents and from about 1 to 20% by weight of water.

3. A composition as claimed in claim 1 wherein the total amount of ester quat is from 60 to 85% by weight.

4. A composition as claimed in claim 1 wherein the total amount of ester quat is from 65 to 80% by weight.

5. A composition as claimed in claim 1 wherein the fatty acid mixture contains 52 to 90% by weight of saturated C₁₈-fatty acid.

6. A composition as claimed in claim 1, wherein the fatty acid mixture contains 55 to 85% by weight of saturated C₁₈-fatty acid.

7. A composition as claimed in claim 1, wherein the fatty acid mixture is fully hydrogenated.

8. The concentrated esterquat composition as claimed in claim 1 containing optionally additional ingredients such as stabilizers and/or other additives selected from the group of specific organic and/or inorganic compound, preferably electrolytes and/or short amines derivates.

9. A composition as claimed in claim 1 containing ZnCl₂, AlCl₃, ZnSO₄ or Al₂(SO₄)₃ as stabilizers.

10. A composition as claimed in claim 1 containing 0.002 to 10% by weight of a stabilizer.

11. A composition as claimed in claim 1 containing as stabilizer an amine having at least one hydroxyethyl group.

12. A concentrated esterquat composition especially suitable for low temperature process for production of a stable, homogenous and viscous liquid softener formulation essentially comprising:
from about 50 to 95% by weight of an esterquat compound of the formula 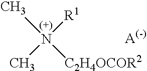
wherein R¹ is —C₂H₄OH or —C₂H₄OCOR², R² is C₁₁-C₂₁-alkyl or alkenyl and A is an anion, as methylsulfate, bromide, iodide and, chloride, wherein the esterquat is prepared by a process comprising the steps of esterifying methyldiethanolamine with at least one fatty acid to form an esterified methyl-diethanolamine and subsequently quarternizing the esterified methyldiethanolamine, wherein the final esterquat product contains at least 50 mol % of diester quat and at least 10 mol % of monoesterquat and has an acid value of less than 0.12 meq/g of esterquat active material, the rest being water and an organic solvent.

13. A composition as claimed in claim 12, wherein the at least one fatty acid contains 52 to 90% by weight of saturated C₁₈-fatty acid.

14. A composition as claimed in claim 12, wherein the at least one fatty acid contains 55 to 85% by weight of saturated C₁₈-fatty acid.

15. A composition as claimed in claim 12, wherein the at least one fatty acid is fully hydrogenated.
